(19) United States
(12) Patent Application Publication
(10) Pub. No.: US 2006/0053613 A1
(43) Pub. Date: Mar. 16, 2006

(54) System and method for hemming vehicle closures

(76) Inventor: Mark A. Savoy, Metamora, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/943,108

(22) Filed: Sep. 16, 2004

(51) Int. Cl. B23P 11/00

(52) U.S. Cl. 29/430; 29/897.2; 29/429; 29/509; 29/796; 29/799; 29/243.5

(57) ABSTRACT

A system (20) and method for hemming a vehicle body closure (32) includes a corner joining station (24) where formed sheet metal outer and inner members (36, 38) are initially joined to each other at their corners, a hemming station (26) where roll prehemming and roll final hemming of the peripheries of the outer and inner members is performed by roll robot hemming apparatus (68), and a delivery station (28) to which the hemmed closure (32) is delivered. At the hemming station (26), a plurality of fixtures (82) of different constructions selectively receive the particular closure member being processed during each cycle so as to have manufacturing flexibility. The fixtures (82) are located between a floor mounted conveyor (74) of robot transfer apparatus (30) and a floor mounted conveyor (84) of roll hemming robot apparatus (68) so that there is no interference between the transfer and hemming manipulations.

### BACKGROUND OF THE INVENTION

1. Field of the Invention

This invention relates to a system and method for hemming vehicle closures and has particular utility for hemming vehicle doors of either the side type or rear gate type, and can also be used to hem vehicle hoods, deck lids and tailgates.

2. Background Art

Vehicle closure hemming is performed by forming an edge of one formed sheet metal member around an adjacent edge of another formed sheet metal member to secure the members to each other. Such hemming is usually performed on the periphery of the members. Also, hemming is performed on outer members of vehicle door closures by forming inner window edges of the outer member about 180° in a reverse direction to provide a more blunt edge.

Conventional hemming systems utilize overhead conveyors supported by a framework including horizontal beams and vertical posts.

Prior art hemming apparatus and methods are disclosed: by U.S. Pat. No. 5,457,981 Brown et al.; U.S. Pat. No. 5,507,165 Hartley; U.S. Pat. No. 5,740,691 Kovarovic et al.; U.S. Pat. No. 5,746,083 Kovarovic et al.; U.S. Pat. No. 5,979,208 Hartley; U.S. Pat. No. 6,029,334 Hartley; U.S. Pat. No. 6,079,250 Scannell et al.; U.S. Pat. No. 6,161,410 Shook et al.; U.S. Pat. No. 6,257,043 Wiens; U.S. Pat. No. 6,369,352 Aman et al.; U.S. Pat. No. 6,425,277 Wiens; U.S. Pat. No. 6,427,510 Schlafhauser et al.; U.S. Pat. No. 6,615,712 Faitel et al.; U.S. Pat. No. 6,619,096 Hartley et al.; and U.S. Pat. No. 6,642,473 Stiers et al.; and by United States published patent application 2003/0209048 Friedman et al.

### SUMMARY OF THE INVENTION

An object of the present invention is to provide an improved system for hemming vehicle body closures.

In carrying out the above object, a system for hemming a vehicle body closure in accordance with the invention includes a joining station for receiving a formed sheet metal outer member of the closure and a formed sheet metal inner member of the closure with associated corners of the outer and inner members located adjacent each other and with peripheries of the outer and inner members extending alongside each other between their corners. The joining station includes corner forming apparatus for forming the corners of the outer member around the adjacent corners of the inner member to initially join the outer and inner members of the closure to each other. Robot transfer apparatus of the system removes the joined outer and inner members of the closure from the joining station. The robot transfer apparatus moves along an axis of conveyance to transfer the joined outer and inner members from the joining station to a hemming station that includes roll hemming apparatus for initial roll prehemming and subsequent roll final hemming the periphery of the outer member around the periphery of the inner member between the corners of the members.

The hemming station of the system may include window edge hemming apparatus for hemming at least the front, top and rear inner edges of a window opening of the outer member.

The joining station of the system includes a turntable and loading apparatus that loads the outer member and the inner member onto the turntable in a cyclical manner. The loading apparatus includes a loading robot that loads the outer member and the inner member onto the turntable in a cyclical manner. The joining station of the system also includes pre prehemming apparatus for pre prehemming a bottom portion of the periphery of the outer member alongside a bottom portion of the periphery of the inner member. The corner forming apparatus of the joining station includes corner formers for providing the forming of the corners of the outer member around the adjacent corners of the inner member to perform the initially joining of the outer and inner members of the closure to each other, and the pre prehemming apparatus includes a robot for performing the pre prehemming of the bottom portion of the periphery of the outer member alongside the bottom portion of the periphery of the inner member.

The system includes a delivery station to which the robot transfer apparatus is moved to transfer the hemmed closure from the hemming station. A floor mounted conveyor of the system moves the the robot transfer apparatus between the joining station, the hemming station and the delivery station. The robot transfer apparatus includes a rotatable transfer head assembly having a first head that removes the joined outer and inner members of the closure from the joining station. The rotatable transfer head assembly has a second head that, upon movement of the robot transfer apparatus to the hemming station, initial receives the previously hemmed closure therefrom whereupon the transfer head assembly is rotated to transfer the joined outer and inner members on the first head thereof to the hemming station prior to movement of the robot transfer apparatus to the delivery station to deliver the hemmed closure on the second head thereof to the delivery station for further processing.

The hemming station of the system includes an inclined fixture that receives the joined outer and inner members of the closure for the initial roll prehemming and subsequent roll final hemming. The roll hemming apparatus includes at least one robot for performing the roll prehemming and the roll final hemming. The inclined fixture is located laterally with respect to the axis of conveyance between the location of the robot transfer apparatus when it deposits the joined outer and inner members on the inclined fixture and the location of the robot of the roll hemming apparatus upon performing the roll prehemming and the roll final hemming. The inclined fixture may be constructed to receive the joined outer and inner members in an upside-down position with a upper window opening thereof at a lower position, and the hemming station also includes window edge hemming apparatus located in horizontal alignment with the upper window opening at the lower position on the fixture and operable to hem window inner edges of the outer member.

A floor mounted transfer conveyor of the system moves the robot transfer apparatus along an axis of conveyance between the joining station, the hemming station and the delivery station. The hemming station is disclosed as including a plurality of fixtures located along the axis of conveyance to selectively receive joined outer and inner members of different constructions for different vehicles and thereby provide manufacturing flexibility. The roll hemming apparatus includes a pair of roll hemming robots for performing the initial roll prehemming and the subsequent roll final hemming. A floor mounted hemming robot conveyor moves the pair of hemming robots along the axis of conveyance for selective use with the fixtures spaced therealong, and the fixtures are located between the transfer conveyor and the hemming robot conveyor.

In an alternate embodiment, the hemming station includes a pair of turntables located along the axis of conveyance. Each turntable includes a pair of fixtures for selectively receiving joined outer and inner members of different constructions for different vehicles to thereby provide manufacturing flexibility. The pair of turntables are located between the transfer conveyor and the hemming robot conveyor.

The delivery station includes a turntable having receptors for receiving each hemmed closure during cyclical operation of the system.

Another object of the invention is to provide an improved method for hemming vehicle body closures.

In carrying out the immediately preceding object, the method for hemming a vehicle body closure in accordance with the invention is performed by positioning a formed sheet metal outer member of the closure and a formed sheet metal inner member of the closure at a joining station with associated corners of the outer and inner members located adjacent each other and with peripheries of the outer and inner members extending alongside each other between their corners. The corners of the outer member are formed around the adjacent corners of the inner member to initially join the outer and inner members of the closure to each other. The joined outer and inner members of the closure are transferred along a conveying axis by a robot transfer apparatus from the joining station to a hemming station. A robot roll hemming apparatus is operated to initially roll prehem and subsequently roll final hem the periphery of the outer member around the periphery of the inner member between the corners of the members.

Operation of a window edge hemming apparatus may be performed to hem certain of inner edges of a window opening of the outer member.

The outer member and the inner member are loaded on at turntable of the joining station for positioning with respect to each other in preparation for the corner forming. The outer member and the inner member are loaded onto the turntable by a loading robot.

A bottom portion of the periphery of the outer member is pre prehemmed alongside a bottom portion of the periphery of the inner member. The corners of the outer member are formed around the adjacent corners of the inner member by corner formers to perform the initially joining of the outer and inner members of the closure to each other. A robot performs the pre prehemming of the bottom portion of the periphery of the outer member alongside the bottom portion of the periphery of the inner member.

A loading robot loads the outer member and the inner member onto a turntable at the joining station for the corner forming that joins the outer and inner members to each other and for robot actuated roll pre prehemming of the bottom portion of the periphery of the outer member alongside the bottom portion of the periphery of the inner member.

The robot transfer apparatus transfers the hemmed closure from the hemming station to a delivery station.

The robot transfer apparatus is conveyed along a conveying axis between the joining station, the hemming station and the delivery station. A rotatable transfer head assembly of the robot transfer apparatus is positioned so a first head thereof removes the joined outer and inner members of the closure from the joining station. Subsequent conveyance of the robot transfer apparatus positions a second head of the of the robot transfer head assembly at the hemming station to initial receive the previously hemmed closure therefrom whereupon the transfer head assembly is rotated to transfer the joined outer and inner members on the first head thereof to the hemming station prior to movement of the robot transfer apparatus to the delivery station to deliver the hemmed closure on the second head thereof to the delivery station for further processing.

The joined outer and inner members of the closure are received from the robot transfer apparatus by an inclined fixture at the hemming station for the roll prehemming and roll final hemming which is performed by at least one roll hemming robot with the inclined fixture located laterally with respect to the axis of conveyance between the location of the robot transfer apparatus when it deposits the joined outer and inner members on the inclined fixture and the location of the robot roll hemming apparatus upon performing the initial roll prehemming and the subsequent roll final hemming.

The joined outer and inner members may be received by the inclined fixture in an upside-down position with a upper window opening thereof at a lower position, and window edge hemming apparatus preforms window inner edge hemming of the outer member from a location in horizontal alignment with the upper window opening at the lower position on the fixture.

The robot transfer apparatus is conveyed by a floor mounted transfer conveyor along the axis of conveyance between the joining station, the hemming station and the delivery station. The joined outer and inner members are received at the hemming station by one of a plurality of fixtures of different constructions for different vehicles along the axis of conveyance to thereby provide manufacturing flexibility. A pair of roll hemming robots perform the initial roll prehemming and the subsequent roll final hemming, and the pair of roll hemming robots are moved on a hemming robot conveyor along the axis of conveyance for selective use with the fixtures which are spaced therealong between the transfer conveyor and the hemming robot conveyor.

In an alternate practice of the hemming method, the robot transfer apparatus deposits the joined outer and inner members at the hemming station on one of a pair of turntables located along the axis of conveyance with each turntable including a pair of fixtures for selectively receiving joined outer and inner members of different constructions for different vehicles to thereby provide manufacturing flexibility. A pair of roll hemming robots perform the initial roll prehemming and the subsequent roll final hemming and a floor mounted hemming robot conveyor moves the pair of hemming robots on a hemming robot conveyor along the axis of conveyance for selective use with the fixtures on the turntables which are spaced therealong between the transfer conveyor and the hemming robot conveyor.

Each hemmed closure is received by a turntable at the delivery station during cyclical operation of the system.

The objects, features and advantages of the present invention are readily apparent from the following detailed description of the preferred embodiments when taken in connection with the accompanying drawings.

### BRIEF DESCRIPTION OF THE DRAWINGS

FIG. 1 is a perspective view of a vehicle closure hemming system constructed in accordance with the invention to perform its hemming method.

FIG. 2 is a top plan view of the hemming system of the invention.

FIG. 3 is a side elevational view of the hemming system taken along the direction of line 3-3 in FIG. 2.

FIG. 4 is an end view of the hemming system taken along the direction of line 4-4 in FIG. 3.

FIG. 5 is a partial perspective view similar to FIG. 1 but illustrating an alternate embodiment.

FIG. 6 is a view illustrating the manner in which outer and inner formed sheet metal members are positioned with respect to each other for the hemming.

FIG. 7 is a sectional view taken along the direction of line 7-7 in FIG. 6 to further illustrate the construction of the outer and inner members that are hemmed by the system.

FIG. 8 is a partial view illustrating the manner in which corners of the outer and inner members are initially joined to each other prior to roll hemming of the peripheries of the members to each other.

FIG. 9 is a view that illustrates the position of a bottom periphery of the outer member adjacent the inner member with a relatively large included angle that permits positioning of the members with respect to each other even with significant curvatures such as illustrated in FIG. 7.

FIG. 10 is a view that illustrates the manner in which roll pre prehemming is performed to form the periphery from the position of FIG. 9 to a generally perpendicular position in preparation for prehemming and final hemming.

FIG. 11 is a view that illustrates the manner in which roll prehemming is performed to form the periphery of the outer member to an angle of approximately 45° in preparation for final hemming.

FIG. 12 is a view that illustrates the manner in which roll final hemming is performed to complete the hemming operation.

### DETAILED DESCRIPTION OF THE PREFERRED EMBODIMENTS

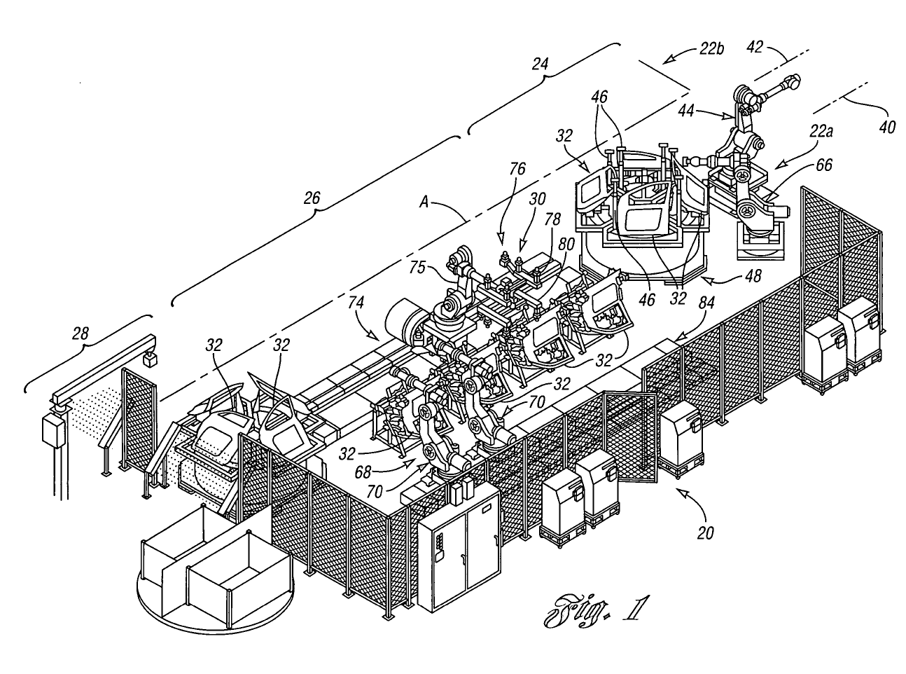

With reference to FIG. 1, a system generally indicated by 20 is constructed to provide hemming of vehicle body closures and is specifically shown to perform hemming of vehicle doors such as side doors or rear doors that have upper window openings. However it should be appreciated that the hemming system can also be utilized to perform hemming of other vehicle closures such as hoods, deck lids and tailgates. Both the system and the hemming method of the invention will be described in an integrated fashion to facilitate an understanding of all aspects of the invention.

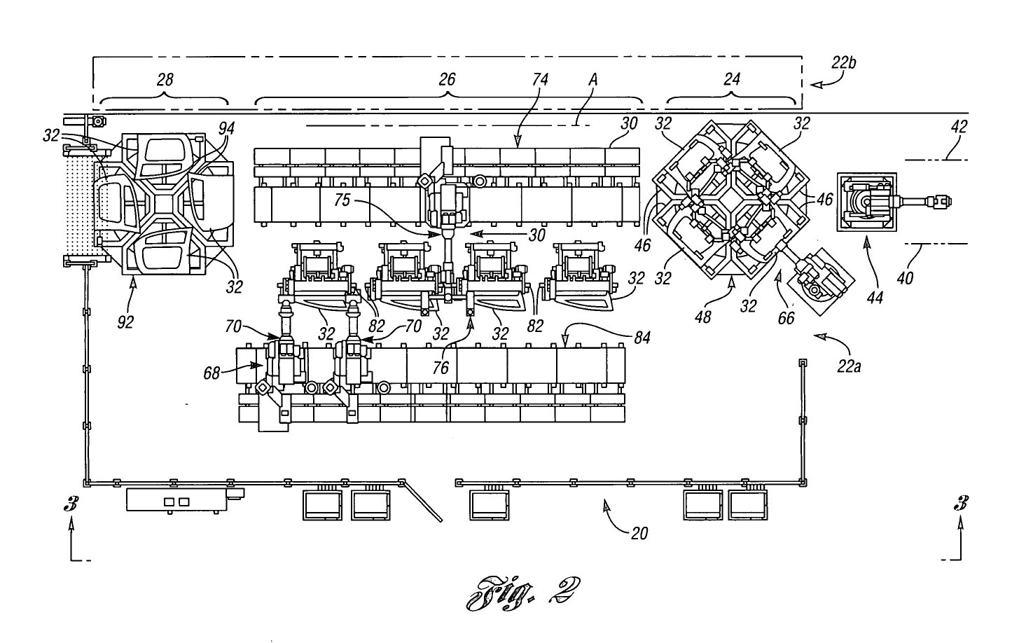

As shown in FIGS. 1 and 2, the hemming system 20 includes a hemming line 22a for hemming left side doors and also includes a partially shown schematically illustrated hemming line 22b for hemming right side doors. The construction of these two lines are the same as each other except for being of opposite hand such that only the left one need be illustrated for an understanding of the invention. Each hemming line includes a joining station 24, a hemming station 26, and a delivery station 28 positioned along an axis of conveyance A. Robot transfer apparatus generally indicated by 30 is conveyed along axis A between the joining station 24, hemming station 26 and delivery station 28 to provide part conveyance in a cyclical manner as is hereinafter more fully described.

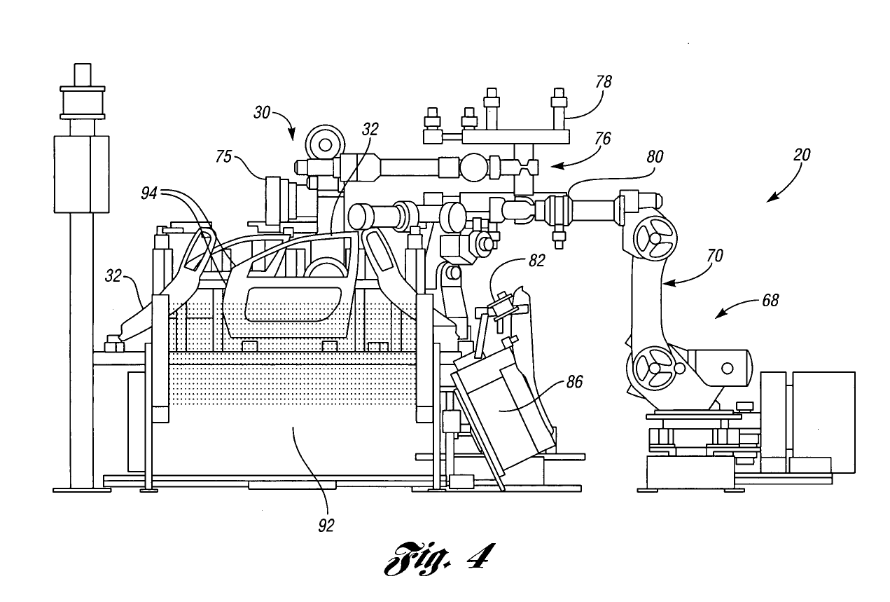

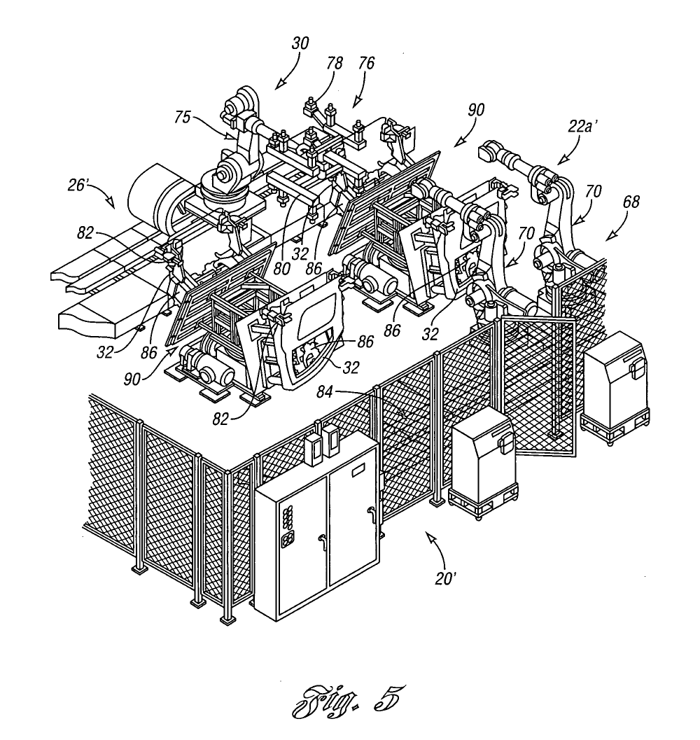

The closure 32 to be hemmed is shown in FIGS. 6 and 7 and illustrated as a vehicle door having an upper window opening 34. More specifically, the vehicle door closure 32 is hemmed upon assembly of a formed sheet metal outer member 36 and a formed sheet metal inner member 38. These outer and inner members are respectively received from part supplies shown schematically by phantom line representation in FIG. 1 and identified as 40 and 42. A loading robot 44 loads the outer and inner members on a part fixture 46 as shown in FIGS. 6 and 7. Preferably a plurality of the fixtures 46 are utilized and are mounted on a turntable 48 as shown in FIGS. 1 through 3. After positioning on the associated fixture 46 as shown in FIG. 6, the outer and inner members have corners 50 and 52, respectively, located adjacent each other and have peripheries 54 and 56, respectively, that extend alongside each other between their corners. Corner forming apparatus 58 of the loading station is indicated generally by 58 in FIG. 6 and includes corner formers 60 that form the associated outer member corner 50 around the adjacent inner member corner 52 as shown in FIG. 8 by a slow speed stamping process to initially join the outer and inner members to each other. During such corner forming, the outer and inner members can be positioned with respect to each other by the loading conveyor or suitable clamps. After the corner forming, the members are thus positioned with respect to each other to facilitate the further processing. As illustrated, the corner forming is performed as shown in FIG. 6 at upper and lower rear locations and at a lower forward location. Such corner forming also allows the subsequent hemming performed by roll hemming, as is hereinafter more fully described, to be performed more rapidly since roll hemming around corners has to proceed relatively slow.

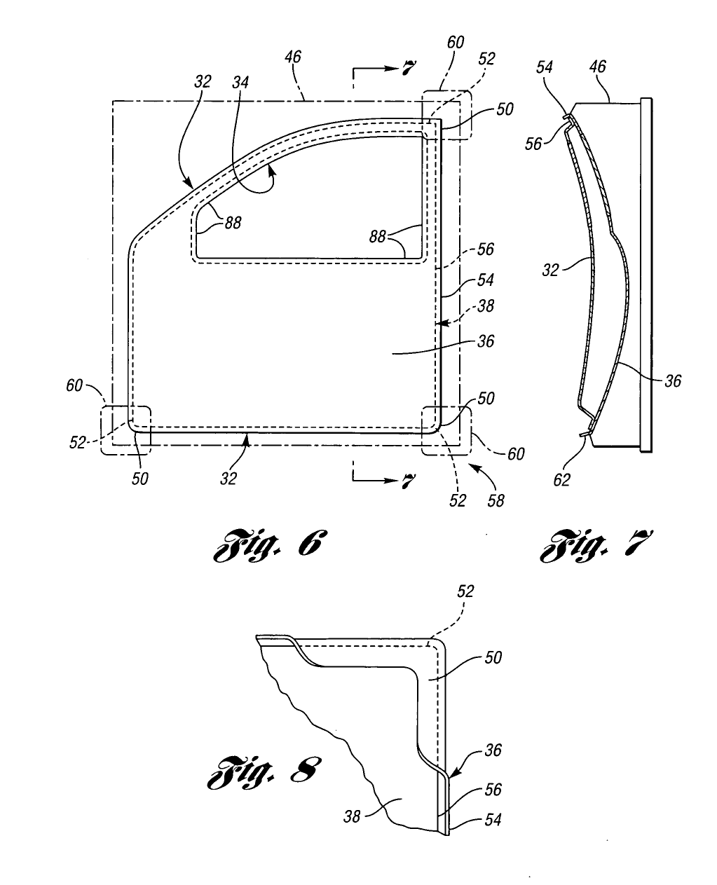

With some door constructions and the curvature involved, a bottom portion 62 of the door periphery, as shown in FIGS. 7 and 9, defines a relatively large included angle, i.e., of about 135°, with respect to the adjacent door. A pre prehem is performed on this bottom portion 66 as shown in FIG. 10 by a roll hemmer whose hemming roll 64 shown in FIG. 10 is operated by a robot 66 of the loading station as shown in FIG. 1. This hemming roll 64 rotates about an axis a that extends generally parallel to the final position of the pre prehemmed bottom portion 62 and is moved along the entire bottom portion by the robot so that the entire periphery of the closure then has its outer member periphery generally perpendicular to the inner member periphery as illustrated in FIG. 10.

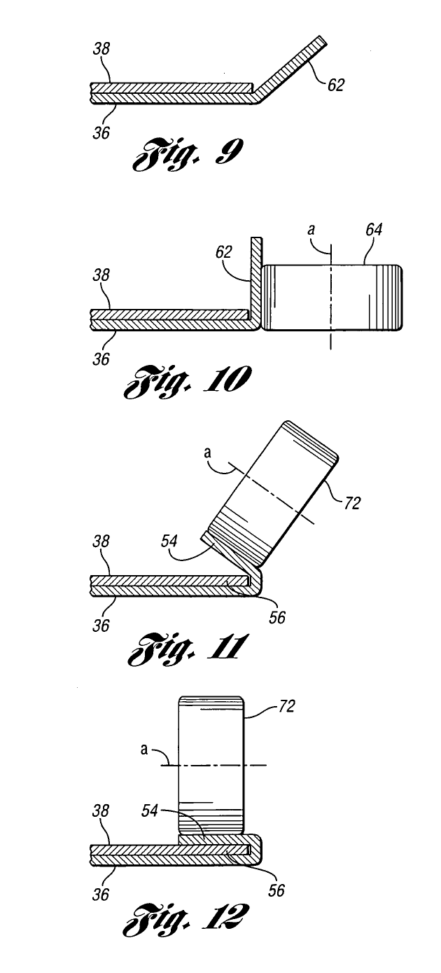

After the corner joining as described above, the robot transfer apparatus 30 shown in FIGS. 1 and 2 transfers the joined outer and inner members of the closure from the joining station 24 to the hemming station 26 upon movement along the axis of conveyance A. The hemming station includes roll hemming apparatus generally indicated by 68 in FIGS. 1 through 3 for initially providing roll prehemming and subsequent roll final hemming of the periphery of the outer member around the periphery of the inner member between the joined corners of the member. More specifically, the roll prehemming is preferably performed by at least one roll hemming robot 70 and preferably by a pair of such roll hemming robots 70. Each roll hemming robot 70 has a hemming roll 72 that is moved at a generally 45° angle to the closure member periphery as shown in FIG. 11 for rotation about an associated axis a to provide prehemming that forms the outer member periphery 54 to approximately 45° with respect to its adjacent portion and with respect to the periphery 56 of the inner member. After the prehemming of the periphery between the previously joined corners, the robot perform final hemming by moving the hemming roll 72 with its axis a generally parallel to the periphery 56 of the inner member 36 so that the outer member periphery 54 has a narrow U-shaped hemmed joint around the inner member as shown in FIG. 12.

After the prehemming and final hemming as described above, the hemmed closure is moved by the robot transfer apparatus 30 from the hemming station 26 to the delivery station 28 in preparation for subsequent processing.

As best shown in FIGS. 1 and 2, the system includes a floor mounted conveyor 74 that moves the robot transfer apparatus 30 along the conveying axis A between the joining station 24, the hemming station 26 and the delivery station 28. The robot transfer apparatus includes a transfer robot 75 having a rotatable transfer head assembly 76 illustrated in FIGS. 1 and 3. This rotatable head assembly 76 includes a first head 78 that is rotatably positioned by the robot transfer apparatus at the loading station to remove the joined outer and inner members of the closure from the joining station. The rotatable transfer head 76 also has a second head 80 that, upon movement of the robot transfer apparatus to the hemming station 26 receives the previously hemmed closure therefrom whereupon the transfer head assembly is rotated to transfer the joined outer and inner members on the first head 78 thereof to the hemming station prior to movement of the robot transfer apparatus to the delivery station to deliver the hemmed closure on the second head 80 thereof to the delivery station for further processing.

As shown in FIGS. 2 and 3, the hemming station has a plurality of fixtures 82 located along the axis of conveyance A in alignment with each other to selectively receive joined outer and inner members of different constructions for different vehicles to thereby provide manufacturing flexibility. As illustrated, there are four of the fixtures 82 so that four different vehicle models can be manufactured during successive cycles of the hemming operation. The closure members 32 are shown on each fixture 32 for purposes of illustration, but at any given cycle there will only be one closure on one of the fixtures. A floor mounted hemming robot conveyor 84 supports the roll hemming robots 70 of the roll hemming apparatus 68 for movement along the axis A so that the roll hemming can be performed at the fixture 82 being utilized with each cycle. The fixtures 82 are located laterally with respect to the axis of conveyance A between the floor mounted robot transfer conveyor 74 and the floor mounted hemming roll conveyor apparatus 84 as shown in FIG. 2. Thus, the closure members to be hemmed are supplied to each fixture 82 from one lateral side and the roll hemming robots 74 operate from the opposite lateral side so as to prevent interference between each other. During the hemming, clamps on the fixtures can secure the closure member periphery and sequentially open to permit passage of the hemming rolls past the clamp while the other clamps remained clamped.

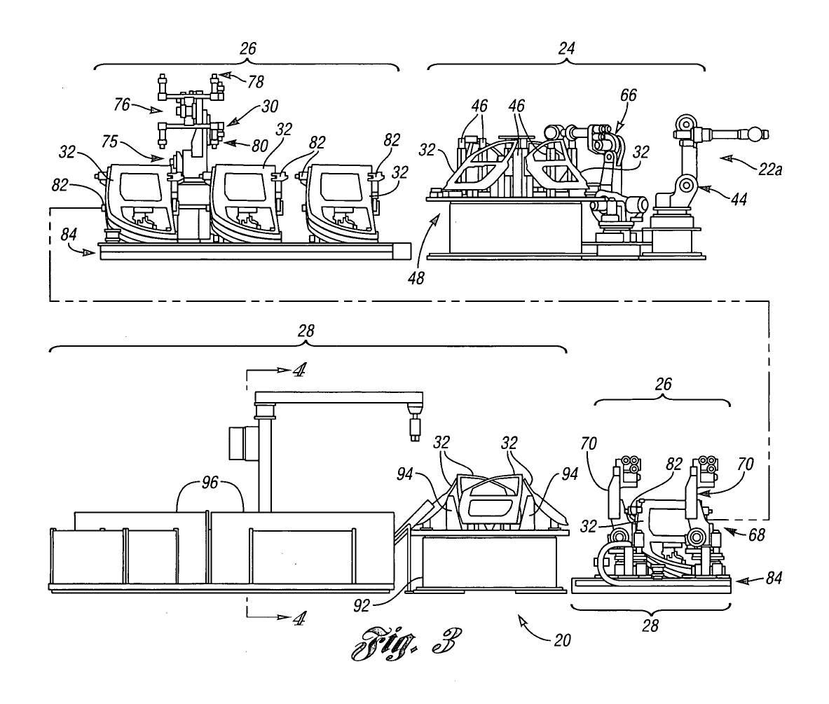

As best illustrated in FIG. 4, each fixture 82 is inclined. Furthermore, as shown in FIG. 3, the inclined fixtures 82 can receive the closure in an upside down position with its window opening located at a lower position. Window edge hemming apparatus 86 associated with each inclined fixture 82 is located in horizontal alignment with the upper window opening 30 at the lower position on the fixture and is operable to hem window inner edges 88 (FIG. 6) of the outer member 36. Such window hemming is conventionally performed on the front, top and rear inner edge of the window opening 34 and is sometimes also performed on the lower inner edge.

In an alternate embodiment, the hemming station 26′ shown in FIG. 5 has a pair of turntables 90 each of which supports a pair of the inclined fixtures 82 and associated window edge hemming apparatus 86. The turntables 90 are located between the floor mounted transfer conveyor 74 and the roll hemming robot conveyor 84 and are rotated to the appropriate direction to receive the particular closure member being processed during each cycle with the transfer apparatus conveyor controlling the position along the axis of conveyance to provide positioning therealong at the appropriate location.

As illustrated in FIG. 3, the delivery station 28 includes a turntable 92 having receptors 94 that received the hem closures 32 for transfer to delivery bins 96 and movement for further processing. The roll pre prehemmer robot 66, the hemming robots 70 and the window edge hemming apparatus 86 can be constructed in accordance with the disclosures of the aforementioned United States and published patent application, the entire disclosures of which are hereby incorporated by reference.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for hemming a vehicle body closure comprising:
a joining station for receiving a formed sheet metal outer member of the closure and a formed sheet metal inner member of the closure with associated corners of the outer and inner members located adjacent each other and with peripheries of the outer and inner members extending alongside each other between their corners, and the joining station including corner forming apparatus for forming the corners of the outer member around the adjacent corners of the inner member to initially join the outer and inner members of the closure to each other;
robot transfer apparatus for removing the joined outer and inner members of the closure from the joining station; and
a hemming station to which the robot transfer apparatus moves along an axis of conveyance to transfer the joined outer and inner members from the joining station, and the hemming station including roll hemming apparatus for initial roll prehemming and subsequent roll final hemming the periphery of the outer member around the periphery of the inner member between the corners of the members.

2. A system for hemming a vehicle body closure as in claim 1 wherein the hemming station includes window edge hemming apparatus for hemming inner edges of a window opening of the outer member.

3. A system for hemming a vehicle body closure as in claim 1 wherein the joining station includes a turntable and loading apparatus that loads the outer member and the inner member onto the turntable in a cyclical manner.

4. A system for hemming a vehicle body closure as in claim 3 wherein the loading apparatus includes a loading robot that loads the outer member and the inner member onto the turntable in a cyclical manner.

5. A system for hemming a vehicle body closure as in claim 1 wherein the joining station includes pre prehemming apparatus for pre prehemming a bottom portion of the periphery of the outer member alongside a bottom portion of the periphery of the inner member.

6. A system for hemming a vehicle body closure as in claim 5 wherein the corner forming apparatus of the joining station includes corner formers for providing the forming of the corners of the outer member around the adjacent corners of the inner member to perform the initially joining of the outer and inner members of the closure to each other, and the pre prehemming apparatus including a robot for performing the pre prehemming of the bottom portion of the periphery of the outer member alongside the bottom portion of the periphery of the inner member.

7. A system for hemming a vehicle body closure as in claim 1 wherein the joining station includes a turntable and loading apparatus including a loading robot that loads the outer member and the inner member onto the turntable in a cyclical manner, the joining station including pre prehemming apparatus for pre prehemming a bottom portion of the periphery of the outer member alongside a bottom portion of the periphery of the inner member, and the corner forming apparatus of the joining station including corner formers that provide the forming of the corners of the outer member around the adjacent corners of the inner member to perform the initially joining of the outer and inner members of the closure to each other.

8. A system for hemming a vehicle body closure as in claim 1 further including a delivery station to which the robot transfer apparatus is moved to transfer the hemmed closure from the hemming station.

9. A system for hemming a vehicle body closure as in claim 8 further including a floor mounted conveyor that moves the robot transfer apparatus between the joining station, the hemming station and the delivery station, the robot transfer apparatus including a rotatable transfer head assembly having a first head that removes the joined outer and inner members of the closure from the joining station, and the rotatable transfer head assembly having a second head that upon movement of the robot transfer apparatus to the hemming station initial receives the previously hemmed closure therefrom whereupon the transfer head assembly is rotated to transfer the joined outer and inner members on the first head thereof to the hemming station prior to movement of the robot transfer apparatus to the delivery station to deliver the hemmed closure on the second head thereof to the delivery station for further processing.

10. A system for hemming a vehicle body closure as in claim 1 wherein the hemming station includes an inclined fixture that receives the joined outer and inner members of the closure for the initial roll prehemming and subsequent roll final hemming, the roll hemming apparatus including at least one robot for performing the roll prehemming and the roll final hemming, and the inclined fixture being located laterally with respect to the axis of conveyance between the location of the robot transfer apparatus when it deposits the joined outer and inner members on the inclined fixture and the location of the robot of the roll hemming apparatus upon performing the roll prehemming and the roll final hemming.

11. A system for hemming a vehicle body closure as in claim 10 wherein the inclined fixture is constructed to receive the joined outer and inner members in an upside-down position with a upper window opening thereof at a lower position, and window edge hemming apparatus located in horizontal alignment with the upper window opening at the lower position on the fixture and operable to hem window inner edges of the outer member.

12. A system for hemming a vehicle body closure as in claim 1 further including a floor mounted transfer conveyor that moves the robot transfer apparatus along an axis of conveyance between the joining station, the hemming station and the delivery station, the hemming station including a plurality of fixtures located along the axis of conveyance to selectively receive joined outer and inner members of different constructions for different vehicles and thereby provide manufacturing flexibility.

13. A system for hemming a vehicle body closure as in claim 12 wherein the roll hemming apparatus includes a pair of roll hemming robots for performing the initial roll prehemming and the subsequent roll final hemming, a floor mounted hemming robot conveyor that moves the pair of hemming robots along the axis of conveyance for selective use with the fixtures spaced therealong, and the fixtures being located between the transfer conveyor and the hemming robot conveyor.

14. A system for hemming a vehicle body closure as in claim 1 further including a floor mounted transfer conveyor that moves the robot transfer apparatus along the axis of conveyance between the joining station, the hemming station and the delivery station, the hemming station including a pair of turntables located along the axis of conveyance, each turntable including a pair of fixtures for selectively receiving joined outer and inner members of different constructions for different vehicles to thereby provide manufacturing flexibility.

15. A system for hemming a vehicle body closure as in claim 14 wherein the roll hemming apparatus includes a pair of hemming robots for performing the initial roll prehemming and the subsequent roll final hemming, a floor mounted hemming robot conveyor that moves the pair of hemming robots along the direction of conveyance for selective use with the fixtures on the pair of turntables spaced therealong, and the pair of turntables being located between the transfer conveyor and the hemming robot conveyor.

16. A system for hemming a vehicle body closure as in claim 1 wherein the delivery station includes a turntable having receptors for receiving each hemmed closure during cyclical operation of the system.

17. A system for hemming a vehicle body closure comprising:
a joining station including a turntable and a robot loading apparatus for depositing a formed sheet metal outer member of the closure and a formed sheet metal inner member of the closure on the turntable with associated corners of the outer and inner members located adjacent each other, with peripheries of the outer and inner members extending alongside each other between their corners and with window opening inner edges of the inner and outer members extending alongside each other to define a window opening at an upper portion of the closure, and the joining station including corner forming apparatus for forming the corners of the outer member around the adjacent corners of the inner member to initially join the outer and inner members of the closure to each other;
robot transfer apparatus for removing the joined outer and inner members of the closure from the joining station;
a floor mounted transfer conveyor for moving the robot transfer apparatus along a direction of conveyance from the joining station;
a hemming station to which the transfer conveyor moves the robot transfer apparatus to transfer the joined outer and inner members to the hemming station from the joining station, the hemming station including roll hemming apparatus including a pair of roll hemming robots for roll prehemming and roll final hemming the periphery of the outer member around the periphery of the inner member between the corners of the members, and the hemming station including window edge hemming apparatus for hemming at least certain of the window opening inner edges of the outer member; and
a delivery station to which the robot transfer apparatus transfers the hemmed closure along the axis of conveyance from the hemming station.

18. A system for hemming a vehicle body closure comprising:
a joining station including a turntable and a robot loading apparatus for depositing a formed sheet metal outer member of the closure and a formed sheet metal inner member of the closure on the turntable with associated corners of the outer and inner members located adjacent each other, with peripheries of the outer and inner members extending alongside each other between their corners and with window opening inner edges of the inner and outer members extending alongside each other at front, top, rear and bottom positions to define a window opening at an upper portion of the closure, and the joining station including corner forming apparatus for forming the corners of the outer member around the adjacent corners of the inner member to initially join the outer and inner members of the closure to each other;
robot transfer apparatus including a rotatable transfer head assembly having first and second heads, and the first head receiving and removing the joined outer and inner members of the closure from the joining station;
a floor mounted transfer conveyor for moving the robot transfer apparatus along a direction of conveyance from the joining station;
a hemming station having a plurality of fixtures along the axis of conveyance, the floor mounted transfer conveyor moving the robot transfer apparatus to the hemming station so the second head of the rotatable transfer head assembly initially receives a previously hemmed closure and the first head thereof transfers the joined outer and inner members to one of the fixtures of the hemming station from the joining station, the hemming station including roll hemming apparatus including a pair of roll hemming robots for roll prehemming and roll final hemming of the members, a floor mounted hemming robot conveyor for moving the pair of roll hemming robots along the axis of conveyance to the fixture being used during each cycle, each fixture including window edge hemming apparatus for hemming at least inner edges of the window opening of the outer member, and the fixtures being located between the transfer conveyor and the hemming robot conveyor; and
a delivery station to which the robot transfer apparatus moves along the axis of conveyance to transfer the hemmed closure on the first head of the rotatable transfer head assembly thereof from the hemming station.

19. A method for hemming a vehicle body closure comprising:
positioning a formed sheet metal outer member of the closure and a formed sheet metal inner member of the closure at a joining station with associated corners of the outer and inner members located adjacent each other and with peripheries of the outer and inner members extending alongside each other between their corners,
forming the corners of the outer member around the adjacent corners of the inner member to initially join the outer and inner members of the closure to each other;
operating a robot transfer apparatus to transfer the joined outer and inner members of the closure from the joining station along a conveying axis to a hemming station; and
operating a robot roll hemming apparatus to initially roll prehem and subsequently roll final hem the periphery of the outer member around the periphery of the inner member between the corners of the members.

20. A method for hemming a vehicle body closure as in claim 19 wherein a window edge hemming apparatus is operated to hem inner edges of a window opening of the outer member.

21. A method for hemming a vehicle body closure as in claim 19 wherein the outer member and the inner member are loaded on at turntable of the joining station for positioning with respect to each other in preparation for the corner forming.

22. A method for hemming a vehicle body closure as in claim 21 wherein the outer member and the inner member are loaded onto the turntable by a loading robot.

23. A method for hemming a vehicle body closure as in claim 19 wherein a bottom portion of the periphery of the outer member is pre prehemmed alongside a bottom portion of the periphery of the inner member.

24. A method for hemming a vehicle body closure as in claim 23 wherein the corners of the outer member are formed around the adjacent corners of the inner member by corner formers to perform the initially joining of the outer and inner members of the closure to each other, and wherein a robot performs the pre prehemming of the bottom portion of the periphery of the outer member alongside the bottom portion of the periphery of the inner member.

25. A method for hemming a vehicle body closure as in claim 19 wherein a loading robot loads the outer member and the inner member onto a turntable at the joining station for the corner forming that joins the outer and inner members to each other and for robot actuated roll pre prehemming of a bottom portion of the periphery of the outer member alongside a bottom portion of the periphery of the inner member.

26. A method for hemming a vehicle body closure as in claim 19 wherein the robot transfer apparatus transfers the hemmed closure from the hemming station to a delivery station.

27. A method for hemming a vehicle body closure as in claim 26 wherein the robot transfer apparatus is conveyed along a conveying axis between the joining station, the hemming station and the delivery station, a rotatable transfer head assembly of the robot transfer apparatus being position so a first head thereof removes the joined outer and inner members of the closure from the joining station and subsequent conveyance of the robot transfer apparatus positioning a second head of the of the robot transfer head assembly at the hemming station to initial receive the previously hemmed closure therefrom whereupon the transfer head assembly is rotated to transfer the joined outer and inner members on the first head thereof to the hemming station prior to movement of the robot transfer apparatus to the delivery station to deliver the hemmed closure on the second head thereof to the delivery station for further processing.

28. A method for hemming a vehicle body closure as in claim 19 wherein the joined outer and inner members of the closure are received from the robot transfer apparatus by an inclined fixture at the hemming station for the roll prehemming and roll final hemming which is performed by at least one roll hemming robot with the inclined fixture located laterally with respect to the axis of conveyance between the location of the robot transfer apparatus when it deposits the joined outer and inner members on the inclined fixture and the location of the robot roll hemming apparatus upon performing the initial roll prehemming and the subsequent roll final hemming.

29. A method for hemming a vehicle body closure as in claim 28 wherein the joined outer and inner members are received by the inclined fixture in an upside-down position with a upper window opening thereof at a lower position, and window edge hemming apparatus preforming window inner edge hemming of the outer member from a location in horizontal alignment with the upper window opening at the lower position on the fixture.

30. A method for hemming a vehicle body closure as in claim 19 wherein the robot transfer apparatus is conveyed by a floor mounted transfer conveyor along the axis of conveyance between the joining station, the hemming station and the delivery station, the joined outer and inner members being received at the hemming station by one of a plurality of fixtures of different constructions for different vehicles along the axis of conveyance to thereby provide manufacturing flexibility.

31. A method for hemming a vehicle body closure as in claim 30 wherein a pair of roll hemming robots perform the initial roll prehemming and the subsequent roll final hemming, and the pair of roll hemming robots being moved on a hemming robot conveyor along the axis of conveyance for selective use with the fixtures which are spaced therealong between the transfer conveyor and the hemming robot conveyor.

32. A method for hemming a vehicle body closure as in claim 19 wherein the robot transfer apparatus is conveyed by a floor mounted transfer conveyor along the axis of conveyance between the joining station, the hemming station and the delivery station, the robot transfer apparatus depositing the joined outer and inner members at the hemming station on one of a pair of turntables located along the axis of conveyance with each turntable including a pair of fixtures for selectively receiving joined outer and inner members of different constructions for different vehicles to thereby provide manufacturing flexibility.

33. A method for hemming a vehicle body closure as in claim 32 wherein a pair of roll hemming robots perform the initial roll prehemming and the subsequent roll final hemming and a floor mounted hemming robot conveyor moving the pair of hemming robots on a hemming robot conveyor along the axis of conveyance for selective use with the fixtures on the turntables which are spaced therealong between the transfer conveyor and the hemming robot conveyor.

34. A method for hemming a vehicle body closure as in claim 19 wherein each hemmed closure is received by a turntable at the delivery station during cyclical operation of the system.

35. A method for hemming a vehicle body closure comprising:
operating a loading robot to position a formed sheet metal outer member of the closure and a formed sheet metal inner member of the closure on a turntable at a joining station with associated corners of the outer and inner members located adjacent each other and with peripheries of the outer and inner members extending alongside each other between their corners;
forming the corners of the outer member around the adjacent corners of the inner member to initially join the outer and inner members of the closure to each other;
conveying a robot transfer apparatus on a floor mounted robot transfer conveyor to transfer the joined outer and inner members of the closure from the joining station along a conveying axis to a fixture of a hemming station;
operating a robot roll hemming apparatus located on the opposite side of the fixture from the floor mounted robot transfer conveyor to initially roll prehem and subsequently roll final hem the periphery of the outer member around the periphery of the inner member between the corners of the members; and
conveying the robot transfer apparatus on the floor mounted transfer conveyor to transfer the hemmed closure member along the axis of conveyance from the hemming station to a delivery station.

36. A method for hemming a vehicle body closure comprising:
operating a loading robot to position a formed sheet metal outer member of the closure and a formed sheet metal inner member of the closure on a turntable at a joining station with associated corners of the outer and inner members located adjacent each other, with peripheries of the outer and inner members extending alongside each other between their corners and with window inner edges of the outer and inner members extending alongside each other to define a window opening;
forming the corners of the outer member around the adjacent corners of the inner member to initially join the outer and inner members of the closure to each other;
conveying a robot transfer apparatus on a floor mounted robot transfer conveyor to transfer the joined outer and inner members of the closure from the joining station along a conveying axis to one of a plurality of fixtures of a hemming station;
conveying robot roll hemming apparatus on a floor mounted robot conveyor located on the opposite side of said one fixture from the floor mounted hemming robot transfer conveyor to initially roll prehem and subsequently roll final hem the periphery of the outer member around the periphery of the inner member between the corners of the members;
operating window hemming apparatus at the hemming station to hem at least some of the inner window edges of the outer member; and
conveying the robot transfer apparatus on the floor mounted transfer conveyor to transfer the hemmed closure member along the axis of conveyance from the hemming station to a delivery station.
